(19) United States
(12) Patent Application Publication
(10) Pub. No.: US 2005/0227139 A1
(43) Pub. Date: Oct. 13, 2005

(54) Device and methods for carring out electrical measurements on membrane bodies

(76) Inventors: Christoph Methfessel, Wuppertal (DE); Frank Lison, Gauting (DE); Ingmar Dorn, Koln (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/523,784

(22) PCT Filed: Jul. 28, 2003
(86) PCT No.: PCT/EP03/08299

§ 371 Date: Apr. 8, 2005

(30) Foreign Application Priority Data
Sep. 8, 2002 (DE) 10236528.8

(51) Int. Cl. H01M 4/86

(52) U.S. Cl. 429/44

(57) ABSTRACT

The invention relates to a measuring arrangement for measuring electrical signals on biological membrane bodies, whereby an electroconductive acess into the membrane body is created by gap junction channels.

The invention relates to devices and methods for studying ion channels and receptors in membranes, in particular to devices and methods for carrying out simultaneous electrophysiological measurements on a collection of biological cells by using connexins or innexins.

1. Electrophysiological Methods

Various methods for studying the electrical activity of ion channels and receptors are known to the person skilled in the art.

In the 50s of the last century, the voltage clamp method was established as a precise and reliable method for determining the activity of ion channels and receptors in the membrane of living cells [1, 2]. In this case, the cell to be studied is touched by two microelectrodes, that is to say sharply drawn glass capillaries filled with salt solution. One electrode measures the potential in the cell interior, that is to say the electrical voltage drop across the cell membrane. The second electrode is used in order to produce an electrically regulated current flow through the cell membrane. In the voltage clamp arrangement, this current flow is regulated so that the potential remains constant over the cell membrane (hence the term “voltage clamp”). The size of the current flowing through the membrane is then a direct and very accurate and pertinent measure of the activity of the ion channels located in the cell membrane, which are activated directly or indirectly by receptors in the cell membrane.

As an alternative, in the “current clamp” method, the current is set to a fixed value which is often zero, and the membrane voltage then freely set up is measured (for which only one microelectrode is needed in the case of a currentless measurement). The value of the voltage then reflects the activity of the receptors and channels located in the cell, but this arrangement is not as informative and precise as the voltage clamp method because the relationship between the activity of the receptors and the measured voltage signal is generally nonlinear in the current clamp arrangement, while the measured current signal and the number of open ion channels are directly proportional in the voltage clamp arrangement.

A drawback of the conventional electrophysiological voltage clamp and current clamp methods is that they entail the insertion of a microelectrode into the cell, so that they are only suitable for very large cells, for example squid axons, muscle cells or frog egg cells. Among all the cells which could be of interest for electrophysiological experiments (for example nerve cells, endocrine cells, culture cells of any kind), most are much smaller and therefore inaccessible to this method. Another drawback is that like all electrophysiological methods, this method is very elaborate and has to be carried out manually by experienced technical staff, so that only a few experiments can be carried out per day and industrial active-agent research (“high throughput screening” or HTS) is therefore precluded.

Another known method for studying the opening and closing mechanisms of ion channels in cell membranes is the patch clamp method, which was developed in the mid-70s by Neher and Sakmann [3, 4]. This method overcame the limitation to large cells, which was previously a constraint in electrophysiology. An electrolyte-filled glass capillary or pipette is not inserted, but placed carefully on the cell membrane and slight suction is applied. This generally gives rise to the so-called gigaseal, an extremely high-impedance, electrically tight connection between the pipette tip and the cell membrane. It isolates a small membrane spot, the “patch”, from the rest of the cell surface and therefore makes it possible to electrically observe individual ion channels in this patch. The “patch” can furthermore be sucked out or electrically broken down, so as to provide a high-quality electrical access to the cell interior, without otherwise damaging or even destroying the cell.

A drawback of the patch clamp method is again the elaborate preparation for the measurements, which allows even experienced electrophysiologists only about 20 measurements per day. This is much less than is required for modern high-throughput methods. Furthermore, the conventional patch-clamp technique requires great experience and much manual dexterity, for which reason it can be automated only to a limited extent.

Work by various study groups and companies is also known with a view to automating or parallelizing the patch clamp method, or another comparable electrophysiological measuring arrangement, so that it allows a higher measurement throughput. These approaches may be categorized as follows:

(1) Automation of the previous patch clamp method with glass pipettes, by carrying out some or all of the elaborate manual working steps by machine under the control of a computer. Some of these approaches are promising and may reduce the experimenter's workload, and therefore increase the number of measurements carried out by a considerable factor, for example tenfold. But all of them are technically very demanding and expensive, and their achievable throughput is still never up to the capacity needed in HTS, which is preferably >100000 tests per day.

(2) Concepts have been developed in which the patch clamp pipette is replaced by a planar or microstructured substrate. For example, this may be a membrane or thin film which is provided with small (μm) holes [5, 6, 7]. The idea is that cells accumulate at the holes and form a seal there similar to the giga-seal in the case of the patch pipette, so that a similar electrophysiological measurement of the electrical properties of the cell membrane is possible through the hole. The planar arrangement, and the possibility in principle of applying cells in parallel to a plurality of holes in a substrate, offers an increase in the measurement throughput up to the HTS range. Various concepts of this type are being developed by different study groups, and they differ primarily by the choice of materials for the substrate and the complexity of the geometry of the holes, even to the extent of elaborate structures in which the substrate simultaneously comprises channels for delivering or removing tests substances or the like.

A common aspect of all these concepts is that they are still substantially unproven. In some cases, there are prototypes in which the accumulation and sealing of cells has been demonstrated. It is nevertheless doubtful whether the electrophysiological lead-off can be achieved in this way with a comparable quality to the patch clamp method. Furthermore, it is still very unclear whether these concepts can be automated or parallelized sufficiently for HTS.

(3) One special technique is a development by Bayer AG, which is currently being marketed by MCS in Reutlingen [8, 9]. Here, Xenopus oocytes are kept in ×96 multiwell plates and automatically injected with cDNA. Automated electrophysiological voltage clamp measurements can be carried out on these oocytes with this arrangement, so that the receptors or ion channels expressed in the oocytes are accessible to an automatic measurement. The measurement throughput could therefore be increased by about tenfold. But this method is restricted exclusively to large cells, such as Xenopus oocytes, and is unsuitable for small cells which constitute the overwhelming majority of specimens. The measurement throughput of this arrangement is comparable to the automated patch clamp methods, and the throughput needed for HTS cannot be achieved in this way. Abbott, Axon and other companies are also engaged in the development of such methods.

Another technique known to the person skilled in the art for the electrical measurement of ion channels and receptors is incorporation into synthetic lipid membranes [10]. These methods were developed as early as the 60s-70s and are characterized by high experimental outlay and low reproducibility of the results, so that they are not currently an alternative for industrial active-agent research. More recent approaches for stabilizing a synthetic lipid membrane by a suitable substrate, so that it is mechanically stronger, can be stored longer and is more reproducible, are however of interest [11]. A prerequisite for electrical measurements on such stabilized synthetic membranes is the choice of a suitable substrate, which at the same time allows good electrical access to both sides of the membrane. The substrates used here are silica gels, for example, which may optionally have been provided with a polymer interlayer to improve the stability and fluidity of the membrane [12]. Bilayers on the substrate can also be stabilized with suitable chain molecules (“tethered bilayers”) [13].

These methods are not yet an alternative for HTS, in particular because the incorporation of functional receptors or ion channels into these synthetic membranes cannot yet be carried out reproducibly, and seems to be fundamentally impossible for many types of more complex membrane receptors. Nevertheless, electrical measurements can be carried out on such synthetic membranes with some fairly simple membrane proteins (gramicidin, alamethicin, melittin, hemolysin) [10] some calcium channels and in particular connexins [14].

2. Connexins, Connexons and Gap Junctions

Biological protein molecules which play a special part in the communication between living cells, so-called connexins, are known to the person skilled in the art. So far, about fifteen different connexins can be singled out on the basis of their amino acid sequence [15, 16]. Connexins occur in all vertebrates and are generally referred to by an abbreviation, for example Cx26. Here, the number indicates the chromatographic size of the connexins in kD. To date, connexins with a molecular weight of between 26 and 56 kD are known. As an alternative to this, there is a second common nomenclature which sorts the connexins into at least 3 classes a, b and c with the aid of structural features, and then numbers the corresponding connexins in the individual classes.

In the cell membrane, six connexins respectively assemble to form a connexon. A connexon is a ring-shaped structure which extends through the cell membrane and is basically capable of forming a very wide nonspecific ion channel or a water-filled pore. But these pores are generally closed so long as the connexon is located in the membrane of a single healthy cell. When two cells that each have mutually compatible connexons in their membranes touch, however, then a gap junction channel (also referred to as an electrical synapse) is formed between two connexons of the opposing cells and spans the distance between the cell membranes. A gap junction channel is generally formed in a few minutes when contact takes place. The gap junction channel which is formed is a structure of generally 12 identical or different connexins, i.e. two connexons. The channel has a sometimes closable central pore with a diameter of about 1.5 to 2 nm. The essential difference from other membrane channels is that the gap junction channels pass through two adjacent cell membranes and therefore make a connection between the intracellular media of the two cells instead of a connection between the cell interior and the external medium.

Gap junction channels then offer inorganic ions and small water-soluble molecules up to a molecular mass of about 1000 Daltons direct passage from the cytoplasm of one cell into the cytoplasm of the other cell. The two cells are therefore connected both mechanically, electrically and metabolically. Gap junction channels belong to the epithelial cell-cell connections and are found in virtually all epithelia and many other tissue types. In general, a plurality of gap junction channels are organized in the form of fields, these structures then being formally referred to as a gap junction.

The gap junction channels of connected cells are generally open and the connexins stretched. If a cell experiences a massive calcium influx from the outside, for example due to injury, then the connection with neighboring cells is broken by the connexins coming together allosterically.

Connexins can be made available by purifying cell membranes from cells that contain connexins, for example eye lenses, heart muscles, smooth musculature or epithelial cells as well as by gene-technological expression of the connexins in bacteria, yeasts or other cells. It is also known that connexins may be connected to a marker, for example a fluorescent protein fragment, so that their presence in a cell membrane can be detected by simple optical methods [17].

Methods by which connexons can be introduced into synthetic membranes or other cell-free systems are known to the person skilled in the art. [14]. Often, these connexons and gap junctions still have the same properties—for example pore size, ion selectivity, electrical behavior—as in their natural environment. It is known that when the membrane surfaces come in contact, a functional gap junction channel is also formed between two connexons that are incorporated into synthetic membranes [18].

It is also known that invertebrates have a functionally similar class of membrane proteins, which are known as innexins [19]. The channels formed by them, however, have a larger pore which offers passage for molecules up to a weight of 2000 Daltons.

It is also known that connections having similar properties to gap junctions occur between the cells in plants as well, these being referred to as plasmodesmata. They also span the intermediate cell wall of neighboring cells and likewise offer a limited number of ions and small molecules passage from cell to cell. In contrast to the channels in living animal tissue, however, plasmodesmata are limited by the plasma membrane.

On the basis of the prior art as described above, it is now a technical object to develop improved methods for carrying out electrochemical studies on membrane bodies. This object is achieved by the arrangements and methods according to the invention which will be described below.

The invention relates to methods and devices for carrying out electrical measurements on membrane bodies, preferably biological membrane bodies. These electrical measurements allow conclusions to be drawn about the state and the behavior of membrane-integrated biomolecules, and about their reaction to prospective effector molecules.

Devices according to the invention contain at least a electrical measuring instrument (1), one or preferably two electrodes (2) and a membrane (3), into which biological molecules (4) that have identical or similar properties to innexins, connexins or connexons are incorporated. Preferably innexins, connexins or connexons are integrated into the membrane. In this case, innexins, connexins or connexons of the same type or innexins, connexins or connexons of different types may respectively be incorporated into the membrane.

On each side of the membrane, there is an electrolytic liquid which preferably has buffer properties. A liquid which has the necessary properties for the survival of living cells is preferably used on one side of the membrane. These include, for example, a suitable concentration and composition of salts, a physiologically compatible pH, and possibly also the presence of nutrients and/or a suitable oxygen concentration.

The electrodes are preferably arranged so that there is one electrode on each side of the membrane. The membrane with the incorporated biomolecules is preferably configured so that it has a high electrical resistance in the absence of open ion channels.

The device according to the invention may be used for the methods according to the invention to carry out electrical measurements on membrane bodies. To that end, biological membrane bodies (5) are selected whose membrane likewise contains biomolecules that have identical or similar properties to innexins, connexins or connexons. Preferably innexins, connexins or connexons are integrated into the membrane of the membrane bodies.

Living cells are particularly preferred membrane bodies in the context of the invention. These cells preferably express connexins or innexins. Cells that do not normally express connexins or innexins may be modified genetically, by transfection with cDNA, mRNA or another form of suitable sequences, or by incorporation of pre-existing connexins or innexins in another way, so that the desired connexins or innexins are incorporated into the membrane of the cells and preferably function there exactly as connexins and innexins in other cells. A stable transfection is preferably selected. If the expression of connexins, innexins and/or of the receptor or ion channel to be studied is coupled with the expression of a fluorescent protein (for example GFP), then it is possible to preselect suitable cells by means of fluorescence spectroscopy. If the cells being used already have connexins, then these may be used directly if suitable. But if another type of connexin is intended to be used, then the incorporation of endogenous connexins into the cell membrane may be temporarily suppressed by adding a suitable oligonucleotide (Cx antisense nucleotide).

Owing to the special properties of biomolecules incorporated into the membrane (3) and into the membrane bodies (5), membrane bodies now preferably accumulate on the membrane over gap junctions (7). These gap junctions that are then formed constitute an electrical access from the membrane side remote from the membrane bodies to the interior of the accumulated membrane bodies.

The detection of functional gap junctions may be carried out via electrical measurements (double voltage clamp) or optical observation of the transfer of dyes with a low molecular weight (for example Lucifer yellow). The latter makes it possible to estimate the coupling of an ensemble of cells by means of image-processing methods.

The membrane bodies according to the invention preferably contain other membrane-integrated biomolecules (8) (targets), the properties of which can be studied by the methods according to the invention. These targets are preferably ion channels or receptors or other biomolecules, which can directly or indirectly affect charge movements through membranes.

Charge movements and/or potential differences through the membranes of the accumulated membrane bodies can now preferably be derived and quantified via the two electrodes.

A particularly preferred method according to the invention involves studying the effects which substances exert on the membrane-integrated biomolecules (targets) to be studied. In this way, it is possible to identify modulators (that is to say inhibitors and activators of the target, and other substances which affect the expression of the target). These substances are prospective active agents for the treatment of diseases which are related to the function of the target in question.

The invention also relates to the active agents identified by the methods according to the invention, as well as to methods for their production.

“Electrical signals” in the context of the invention are physical quantities which are related to the distribution of electrical charges, that is to say electrons, protons or ions, in the system in question. Examples of electrical signals which may be recorded in the devices according to the invention are the electrical current strength, the electrical capacitance or the electrical potential difference, as well as changes and fluctuations in these parameters, for example action potentials.

“Membrane bodies” in the context of the invention are volume elements filled with a liquid and enclosed by a membrane. Membrane bodies according to the invention are preferably biological membrane bodies, for example living cells. This includes cells which have been isolated from living tissue by dissociation (primary cultures). It also includes cells which are kept in culture as established cell lines, for example CHO cells, HEK cells, NIH3T3 cells, HeLa cells as well as transiently transfixed cells or primary cells. Biological membrane bodies in the context of the invention are furthermore artificially produced membrane bodies in which, for example, a lipid double layer encloses a limited volume of an aqueous medium (vesicle). These membrane bodies then preferably contain at least one biological component, for example a polypeptide incorporated into the lipid double layer, a membrane-integrated enzyme, an ion channel or a G-protein coupled receptor. Biological membrane bodies in the context of the invention may also be bacterial cells, fungal cells or cells of other single-celled or multicellular organisms. Biological membrane bodies in the context of the invention are also, for example, protoplasts of fungal cells and plant cells which have been obtained by removing peripheral cell walls or similar structures. Biological membrane bodies in the context of the invention are furthermore also membrane bodies which—for example synaptosomes—have been produced by cleavage or purification from the membranes of living organisms, or which have been obtained by purifying such specimens with synthetic lipid vesicles.

An “electrical measuring instrument” in the context of the invention is a device which makes it possible to record and optionally quantify electrical signals.

The “membrane potential” is the electrical potential difference between the opposite sides of a membrane.

“Active agents” in the context of the invention are substances which can affect the activity of biological molecules. Preferred active agents in the context of the invention are those which specifically affect the activity of individual biological molecules or groups of biological molecules. Particularly preferred active agents are those which affect the activity of receptors and/or ion channels.

“Supported bilayers” are membranes which, on one side, are in contact with or immediately next to a suitable solid, porous or gel-like material. This makes them mechanically more stable and more capable of bearing load compared with freestanding membranes.

The invention relates to
1. a measuring arrangement for measuring electrical signals on membrane bodies, containing an electrical measuring instrument (1), electrodes (2), a membrane (3). containing connexins or innexins (4), and a membrane body (5) likewise containing connexins or innexins (6), characterized in that an electrically conducting access is produced from the membrane side facing away from the membrane body to the interior of the membrane body by gap junction channels (7).
2. a method for measuring electrical signals on biological membrane bodies, characterized in that a measuring arrangement according to point 1 is used.
3. a method according to point 2, the measured electrical signal being
   i) the membrane potential of the membrane body,
   ii) the electrical current flowing through the membrane, and/or
   iii) the electrical capacitance of the membrane.
4. a method for identifying active agents which affect the properties of receptors and/or ion channels (8), characterized in that
   i) at least one membrane body (5) containing said receptors and/or ion channels is brought in contact with at least one test substance, and
   ii) at least one electrical signal is measured on the membrane body or the membrane bodies with a measuring arrangement according to point 1,
      those test substances which affect the measured electrical signal being selected as active agents.
5. a method for transporting substances into a membrane body or out from a membrane body, characterized in that the substance enters the membrane body or leaves the membrane body through gap junction channels. In this case, the substance to be transported follows an electrical potential gradient, a concentration gradient, or a pressure gradient across the membrane of the arrangement according to the invention.
6. a measuring arrangement according to point 1, said membrane being configured as a supported bilayer.
7. a measuring arrangement according to point 6, said membrane being configured as a supported bilayer on a silica gel substrate with a lipid-compatible polymer interlayer, or as a “tethered bilayer”.
8. a measuring arrangement according to point 1, with the membrane covering the end of a capillary.
9. the use of a measuring arrangement according to point 1 as a biosensor for the detection of substances.
10. the use of connexin-doped membranes as a substrate for the growth of living cells in cell culture, with the facility to monitor the electrical activity of the cells.
11. the measuring arrangement according to point 1, characterized in that said membrane is in the form of a living cell.

The devices and methods according to the invention will be further illustrated by the following exemplary embodiments. The exemplary embodiments are merely preferred versions of the invention and do not imply any restriction of the subject-matter of the invention.

### DRAWINGS

FIG. 1 shows a typical measuring arrangement in the context of the invention, with an electrical measuring instrument (1), electrodes (2), a membrane (3) containing connexins or innexins (4), a membrane body (5), gap junction channels (7) and targets (8).

### EXAMPLE 1

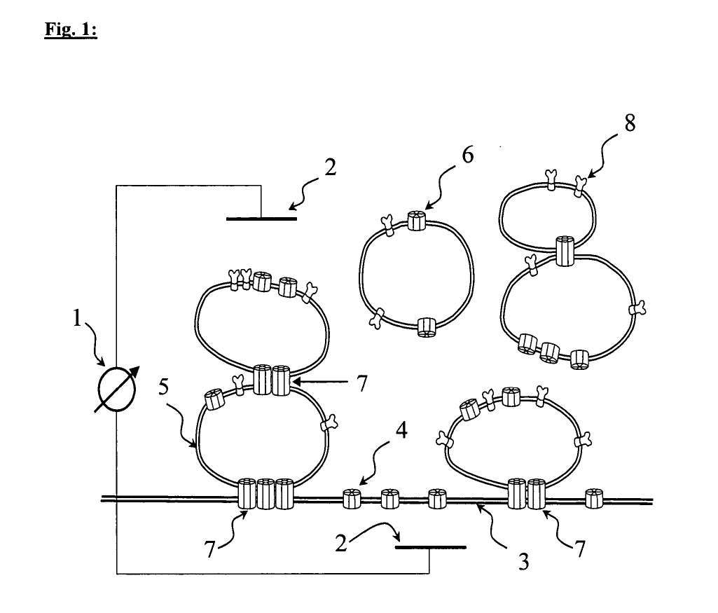

A measuring arrangement for measuring electrical signals on membrane bodies is depicted in FIG. 1. It consists of an electrode (for example a gold electrode) at the bottom of a small chamber, for example a chamber in a microtiter plate. An electrically tight synthetic membrane (3) is fitted above the electrode, and there is an electrolyte solution as an ion reservoir in the intermediate space between the membrane and the electrode. The measuring arrangement also has a second electrode, which is located above the synthetic membrane. Functional hemi-channels (connexons) are incorporated into the synthetic membrane so that they can diffuse freely in the membrane and their normally extracellular domains are above (trans) the membrane. Suitable connexin types are used according to the intended purpose. The connexons may optionally be made up of more than one connexin (heteromeric connexons). The suitable connexins will be selected according to the requirements of the test envisaged. A procedure is adopted so that a minimal electrical signal is measured when the active agents to be studied have not been added, and a maximal increase in the observed signal occurs when there is an interaction between the active agents and the ion channels and/or receptors (8) to be studied.

In order to carry out a measurement, a suspension of suitable cells is added to said chamber which already contains the synthetic membrane, as described above. These cells (5) have at least one ion channel or receptor (8) to be studied in the cell membrane, as well as hemi-channels (6) which suitably form functional gap junctions (7) with the hemi-channels in the synthetic membrane (4) of the measuring arrangement.

The hemi-channels in the synthetic membrane are initially closed, so long as there are no cells where they are located. This is ensured by applying an electrical voltage across the membrane. When a cell comes in contact with the synthetic membrane, contact also takes place between hemi-channels in the synthetic membrane and the cell membrane, so that gap junctions are formed. It is entirely feasible for additional gap junctions to be formed between neighboring cells, or for many of the cells to set up a conducting connection to the ion reservoir only indirectly via other cells. This, however, is not an impediment to this arrangement being used according to the invention. In fact, it can even lead to an amplification of the observed signal which further improves the sensitivity of the measuring arrangement.

Connexons with a voltage behavior such that they are closed as hemi-channels, or are open as hemi-channels only at a low potential difference (for example less than 20 mV) across the cell membrane and are closed at a larger potential difference, are particularly suitable for the measuring arrangement.

If the addition of a prospective active agent or stimulation by an applied electrical signal then causes a change in the state of the ion channels or receptors in the cell membrane, which in turn leads to a change in the membrane potential of the cells, then this leads to an ion current for those cells which have directly or indirectly set up a conducting connection to the ion reservoir below the synthetic membrane. This ion current is measured. Electrical measuring equipment such as that known to the person skilled in the art from typical electrophysiological measurements, for example patch-clamp measurements, is suitable for this.

A current signal is thus obtained as the measurement result, which corresponds to the total cumulative current flow through the cell membranes of all those cells which have a conducting connection to the ion reservoir via the incorporated gap junctions.

As an alternative to this, the electrical voltage may also be measured so that a voltage signal is obtained which reproducibly reflects the behavior of the ion channels and receptors in these same cell membranes. The described measuring arrangement is therefore suitable for directly and indirectly determining the electrical behavior of ion channels and receptors with high precision and good time resolution, and for accurately detecting and evaluating changes in this behavior, which are initiated for example by known or prospective active agents. The time resolution of the measuring arrangement is determined by the electrical properties of the gap junctions, which have a time resolution in the sub-millisecond range in their natural function.

### EXAMPLE 2

### Determination of the Total Membrane Surface Area

Creation of the intended lead-off configuration, in which the cells applied to the substrate acquire an electrical connection to the ion reservoir by forming gap junctions, can likewise be monitored by electrical measurements. In particular, by suitable electronic measuring methods which are known to the person skilled in the art, it is possible to determine the electrical capacitance of the membrane and of the membrane bodies which are in connection with it via gap junctions. This method is suitable for finding the total membrane surface area of the system, and therefore determining the number of accumulated cells connected to the membrane via gap junctions. This signal can also be used to determine the effect of test substances on this arrangement. In particular, the occurrence of exocytosis in the accumulated membrane bodies can be established in this way.

As an alternative, the number of cells which have entered into a conducting connection with the ion reservoir is optically detected by adding a suitable dye to the ion reservoir or to the cells. Dyes with a low molecular weight which can diffuse through gap junction channels, for example Lucifer yellow, are suitable for this.

Having determined the number of accumulated and therefore electrically connected cells, it is possible to normalize the measurement signal so that the results of other experiments using similar but different experimental arrangements can be compared directly.

### EXAMPLE 3

### Parallelized Methods

The layout as described in Example 1 is modified so that a plurality or sizeable number of the described chambers are arranged next to one another, for example in such a way that each chamber of a microtiter plate constitutes a measuring arrangement according to Example 1. The individual measuring chambers are read out sequentially, in groups or simultaneously. Inter alia, multichannel amplifier systems such as are known from the MEA (multi-electrode array) technique, or the detectors in high-energy physics, may be used for this.

The microtiter plates used are, for example, those with 96, 384, 1536 or any other number of chambers. The measuring arrangement is thus preferably configured so that it is mechanically and geometrically compatible with the HTS systems and installations already established in active-agent research, so that there are no impediments to technical use of the invention for practical active-agent research. Existing equipment for pipetting and dispensing may then continue to be used. Merely the detection system is supplemented with a suitable reading head which is capable of reading the electrical signals out from the microtiter plates.

Literature:

1. Hodgkin, A. L., A. F. Huxley and B. Katz (1949). Ionic currents underlying activity in the giant axon of the squid. Arch. Sci. Physiol. 3, 129-150.
2. Hodgkin, A. L., A. F. Huxley and B. Katz (1949). Measurements of current-voltage relations in the membrane of the giant axon of Loligo. J. Physiol. (London) 117, 500-544
3. Neher E. and B. Sakmann (1975) Single-channel currents recorded from membrane of denervated frog muscle fibres. Nature 260, 779-802
4. Hamill, O. P., A. Marty, E. Neher, B. Sakmann and F. J. Sigworth (1981). Improved patch-clamp techniques for high-resolution current recording from cells and cell-free membrane patches. Pflügers Archiv 391, 85-100
5. Sigworth, F J and Klemic, K G (2002) Patch clamp on a chip. Biophys. J. 82, 2831-2832
6. Fertig, N., Blick, R. H. and Behrends, J. C. (2002) Whole Cell Patch Clamp Recording Performed on a Planar Glass Chip. Biophys. J. 82, 3056-62
7. Rosat, J.-P., Brueggemann, A. and Schmidt, C. (2002) Patch-clamp on a chip—a reality. Analytica 2002 pp. 4-10
8. Schulz R, S. Bertrand, K. Chamaon, K. H. Smalla, E. D. Gundelfinger and D. Bertrand (2000) Neuronal nicotinic acetylcholine receptors from Drosophila: Two different types of α subunits coassemble within the same receptor complex. J. Neurochem. 74, 2537-2546
9. Decker K. and C. Methfessel (2002) Automatisierte elektrophysiologische Wirkstoffsuche [automated electrophysiological active-agent research]. Laborpraxis/LabFuture, pp. 72-79
10. Hanke, W. (1985) Reconstitution of Ion Channels. CRC Critical Reviews Biochemistry 19, 1-44
11. Sackmann E. and Tanaka M. (2000) Supported Membranes on soft polymer cushions: fabrication, characterization and applications TIBTECH 18, 58-64
12. Loidl-Stahlhofen, A., Schmitt, J., Nöller, J., Hartmann, T., Brodowsky, H., Schmitt, W. and Keldenich, J. (2001) Solid-Supported Biomolecules on Modified Silica Surfaces—A Tool for Fast Physicochemical Characterization and High-Throughput Screening. Advanced Materials 13, 1829-1834
13. Raguse, B., Braach-Maksvytis, V., Cornell, B. A., King, L. G., Osman, P. D. J., Pace, R. J. and Wieczorek, L. (1998). Tethered Lipid Bilayer Membranes: Formation, and Ionic Reservoir Characterization. Langmuir 14, 648-659
14. Mazet, J. L., Jarry, Th., Gros, D. and Mazet F. (1992) Voltage Dependence of liver gap-junction channels reconstituted into liposomes and incorporated into planar bilayers. European Journal of Biochemistry 210, 249-256
15. Austin, C. D. (1993) The Connexins: A Family of Gap Junction Proteins. Einstein Quarterly Journal of Biology and Medicine 10, 133-142
16. Goodenough, D. A., J. A. Goliger, and D. L. Paul (1996) Connexins, Connexons, and intercellular communication. Annu. Rev. Biochem. 65:475-502
17. Jordan K., Solan J. L., Dominguez M., Sia M., Hand A., Lampe P. and Laird D. W. (1999) Trafficking, Assembly, and Function of a Connexin43-Green Fluorescent Protein Chimera in Live Mammalian Cells. Molecular Biology of the Cell 10, 2033-3050
18. Brewer, G. J. (1991) Reconstitution of lens channels between two membranes. Chapter 19 in: Biophysics of Gap Junction Channels, Editor: C. Peracchia, CRC Press Boca Raton, Ann Arbor, Boston.
19. Phelan, P. (2000) Gap Junction Communication in Invertebrates: The Innexin Gene Family. Current Topics in Membranes 49, 389-422

1.-10. (canceled)

11. A measuring arrangement for measuring an electrical signal on a membrane body, comprising:
a) an electrical measuring instrument;
b) electrodes;
c) a membrane comprising at least one connexin or innexin; and
d) a membrane body comprising at least one connexin or innexin;
wherein the connexins and/or innexins in the membrane and membrane body cooperate to form at least one gap junction channel, and an electrically conducting access is produced from a side of the membrane facing away from the membrane body to an interior of the membrane body by said at least one gap junction.

12. The measuring arrangement according to claim 11, wherein the membrane is configured as a supported bilayer.

13. The measuring arrangement according to claim 11, wherein the membrane covers an end of a capillary.

14. The measuring arrangement according to claim 11, wherein the membrane is in the form of a living cell.

15. A method for measuring an electrical signal on a biological membrane body, comprising:
a) providing a measuring arrangement according to claim 11; and
b) measuring an electrical signal on the membrane body.

16. The method according to claim 15, wherein the electrical signal is at least one of:
a) the membrane potential of the membrane body;
b) the electrical current flowing through the membrane; and/or
c) the electrical capacitance of the membrane.

17. A method for identifying an active agent that affects a property of a receptor and/or ion channel, comprising:
a) providing a measuring arrangement according to claim 11, wherein the membrane body comprises a receptor and/or ion channel;
b) bringing the membrane body into contact with at least one test substance;
c) measuring at least one electrical signal on the membrane body; and
d) determining whether the at least one electrical signal has been affected by the presence of the at least one test substance, wherein an effect on the electrical signal by the test substance is taken as an indication that the test substance is an active substance.

18. A method for transporting a substance into or out of a membrane body, comprising:
a) establishing at least one gap junction channel in the membrane body; and
b) driving a substance into or out of the membrane body by establishing a concentration gradient, an electrical voltage difference or a pressure difference across the at least one gap junction channel.

19. A method for detecting the presence of a substance in a system, comprising:
a) providing a membrane arrangement according to claim 11;
b) measuring at least one electrical signal on the membrane body; and
c) determining whether the electrical signal has been affected from a standard, wherein an effect on the electrical signal is taken as an indication that a substance is present.

20. A method for growing living cells, comprising culturing the cells on a substrate comprising at least one connexin-doped membrane.
